(19) United States
(12) Patent Application Publication
(10) Pub. No.: US 2015/0242750 A1
(43) Pub. Date: Aug. 27, 2015

(54) Asymmetric Rankers for Vector-Based Recommendation

(71) Applicant: Google Inc., Mountain View, CA (US)

(72) Inventors: John Roberts Anderson, San Anselmo, CA (US); Ryan Michael Rifkin, Oakland, CA (US); Douglas Eck, Palo Alto, CA (US)

(73) Assignee: Google Inc., Mountain View, CA (US)

(21) Appl. No.: 14/188,086

(22) Filed: Feb. 24, 2014

(51) Int. Cl. G06N 5/04

(52) U.S. Cl. CPC G06N 5/04

(57) ABSTRACT

An asymmetric system for obtaining recommendations is disclosed. A reference magnitude may be obtained from a seed and/or a user model. The reference magnitude may be utilized to adjust the magnitude of candidate vectors that represent one or more items in a multi-dimensional vector space. This permits an item to receive credit for a popularity up to a certain point. The dot products between the adjusted candidate vectors and the seed vector may be obtained and, in some configurations, ranked. The highest dot products may correspond to items that are preferred to be recommended according to an implementation.

### BACKGROUND

Recommender systems often utilize high dimensional vector space representations and obtain candidates to recommend in response to a query (e.g., a seed) based a similarity metric that may be calculated as a vector operation in the high dimensional space. The length of these vectors may be representative of the popularity of an item. Typically a dot product or cosine similarity scores between the vector representing the seed and those representing the candidates in the high-dimensional vector space provide a basis to rank the similarity of the items. But dot product based ranking systems often recommend popular items which are similar in only broad terms. The cosine ranking systems often find recommendations that, while similar, tend to be too obscure to be meaningful.

### BRIEF SUMMARY

According to an implementation of the disclosed subject matter, an indication of a vector space may be received. The vector space may include one or more vectors and each vector in the vector space may represent an item. A seed may be received. The seed may be represented as a vector that defines a direction in the vector space. A seed or an item may refer to a user model a song, a movie, a picture, a book, etc. A reference magnitude may be obtained. A reference magnitude may be obtained, for example, from a magnitude of the seed vector or that of an inferred value for the depth of the user interest in this genre. A magnitude of each of a candidate vectors in the vector space may be adjusted based on the reference magnitude. Each of the candidate vectors represents the item in vector space. For example, a candidate vector may be selected based on the direction of the seed vectors. One or more dot products may be generated by a processor. Each dot product may be computed between one of the candidate vectors with the adjusted magnitude and the seed vectors. At least one of the candidate vectors may be provided based on at least one of the dot products. In some configurations, the dot products may be ranked and a portion of the candidate vectors may be selected based on the ranking of the dot products.

In an implementation, a system is provided that includes a database and processor connected thereto. The database may store one or more vectors that exist in a vector space. Each vector may represent an item. The processor may be configured to receive an indication of a vector space. The indication may include at least a portion of the vectors. The processor may receive a seed that may be represented as a seed vector that defines a direction in the vector space. It may obtain a reference magnitude and adjust a magnitude of candidate vectors in the vector space based on the reference magnitude. Each candidate vector may represent the item in the vector space. The processor may be configured to generate a dot product between each candidate vector with adjusted magnitude and the seed vector. The processor may provide at least one of the candidate vectors based on at least one of the dot products.

In an implementation, an indication of a vector space that includes vectors, each of which represents an item. A seed may be received that corresponds to a request for a recommendation. A reference magnitude may be obtained. The magnitudes of candidate vectors in the vector space may be adjusted based on the reference magnitude. Each of the candidate vectors may represent an item in the vector space. Distances may be obtained each one of the candidate vectors with adjusted magnitude and the seed vector. At least one of the candidate vectors may be provided based on at least one of the distances obtained.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 is an example process for obtaining a dot product between adjusted candidate vectors and the seed vector according to an implementation disclosed herein.

FIG. 4 is an example system for obtaining a dot product between adjusted candidate vectors and the seed vector according to an implementation disclosed herein.

FIG. 5 is an example process for generating distances between adjusted candidate vectors and the seed vector and providing at least one candidate vector based upon at least one of the generated distances as disclosed herein.

### DETAILED DESCRIPTION

Although examples described here and elsewhere refer to implementations in the context of music or songs, it will be understood by one skilled in the art that the implementations disclosed herein may be applied to other areas in which a recommendation is sought. For example, it may be applied to a shopping recommendation system, other forms of digital content (e.g., movies, books, applications, etc.), a user model, a collection of digital content, etc.

There are many systems available today in which a user may submit a query and ask the system to return content that is similar to the query. The query may represent a seed and may exist in a high-dimensional vector space as a vector. As stated above, there are currently two systems to find the closest target song in a high dimensional vector space that contains at least two songs (and often has millions) represented by vectors for which the length of each vector represents the popularity of a given song. One system can obtain the vectors closest to the seed, as represented by a vector. For example, a 100-dimensional space may have millions of songs, each represented by a 100-dimensional vector. The dot product (e.g., inner product) between each of these millions of songs and the seed vector may be obtained and the dot products above a threshold value may be returned to a query based on the seed. The returned results may be ranked based on the value of the dot products. Dot products that are the largest may be those that are popular and closest to the seed vector in the vector space. A second system is to normalize the vectors before determining the dot products. For example, a unit vector may be defined for the seed vector and used to normalize the other vectors of the high-dimensional space before computing the dot product. This system tends to produce specific recommendations for content that is unpopular.

The implementations disclosed herein do not treat the response to a request for a recommendation as a symmetric. That is, in some instances, an obscure recommendation based on an obscure seed may be fine while an obscure recommendation based on a popular seed may not be. For example, a user may ask a music recommendation system to recommend songs similar to the popular band ABC (e.g., songs similar to those produced by band ABC). A recommendation for a song from the obscure band XYZ, which is a side project of one of the members of band ABC, would not be a particularly good recommendation. A recommendation for popular bands DEF and GHI would be preferred because they are similar to band ABC in popularity and music type. On the other hand, if obscure band XYZ is the seed, there would like be no point in recommending band ABC to the user because the user almost certainly is already aware of who band ABC is. In this case, a recommendation for other obscure bands RST and UVW would be better recommendations.

Implementations disclosed herein can involve constructing a dot product-like scoring system carries out this process computationally on a large scale. In an implementation, the dot product between the seed and limited number of candidate vectors may be scored. The length of the candidate vectors may be limited based on the length of the seed vector before the dot product is obtained. As disclosed herein, a reference popularity can be determined and/or obtained and an example of the subject of a recommendation (e.g., digital content such as a song) may receive credit for being popular up to that reference popularity, but no additional credit if the example subject has passed the reference popularity. That is, once the example subject is popular enough, it does not receive a higher rank or score than another example of the subject of the recommendation that may be semantically closer and less popular. The recommender may be asymmetric because the popularity of the seed may be utilized as the target reference. A reference popularity is interchangeable with a reference magnitude as disclosed herein. Candidate vectors representing examples of a subject (e.g., shopping items, digital content, user models, etc.) may receive credit for being popular up to the point of the popularity of the seed, but the candidates will not receive additional credit if they are more popular than the seed.

In some configurations, the reference popularity may be adjusted based on other features or tailored as desired. For example, the reference popularity may be established to be 10% above or below the seed's popularity. Other values may be utilized in practice as is necessary to achieve the desired specificity of the recommendation system. For example, in a shopping recommendation system, it may be determined that a reference popularity of 112% of the seed's popularity provides better-received recommendations as judged from user feedback. In a music recommendation system, however, it may be determined that using just the seed's popularity as the reference popularity provides better-received recommendations. The determination may be based on user feedback and/or user response to the recommendations such as how long a user views or consumes the recommended content, user purchases of recommended content, and/or an analysis of what content was recommended and what content was actually consumed by the end-user.

Information about a user may be utilized to adjust the reference popularity. For example, a user may be well-acquainted with jazz music and the seed may be a popular jazz artist. The reference popularity in this case may be lowered in this case to cause lesser-known artists that are close in terms of style to the popular jazz artist a greater probability of being returned in response to the query or appearing in the list of recommendations returned. A user who has just listened to a popular jazz artist and requests a recommendation based thereon but for whom there is either no information about the user's musical tastes on which a prediction can be formed or for whom there is no indication regarding jazz music in particular, the user is likely listening to a famous jazz musician because the artist is famous. The system, therefore, should recommend another famous jazz artist to the user. Thus, the more expert a user is regarding a subject area for which a recommendation is sought, the more willing the system may be to recommend an example of the subject area that may be less popular or not popular.

Information about the user on which a determination regarding the user's level of knowledge or expertise for a given subject area may be obtained from a variety of sources including a search history, a user profile, a user's digital content collection, a purchase history, a browsing history, a recommendation history, a vote history, etc. A user profile may contain, for example, a user's age, location, genres that interest a user, etc. A search history may be obtained from websites the users has visited or searches conducted on an application marketplace that provides or makes available for consumer/user consumption various digital content (e.g., books, movies, songs, applications). For example, a cookie on the user's device (e.g., a mobile device, laptop, desktop PC, tablet) may report websites a particular user has visited. A browsing history may refer to items for which the user has requested more information. It may refer to a length of time a user has spent on a page containing information related to a particular item or piece of digital content. A vote history may refer to instances where the user has provided an indication of the user's preference for content. For example, a user may award stars to indicate the user's interest or enjoyment of the various content that is in the user's personal collection or that the user has consumed online. A recommendation history may refer to items or content that has been previously recommended to the user and the user's response thereto. For example, a song may have previously been recommended to the user and the user may have responded by voting down the content, dismissing the content, or listening to the song for a short period of time before skipping ahead to the next song. These indications may be interpreted as negative factors that would weigh against subsequently recommended the song to the user even in the event that it would otherwise be the highest ranked song to recommend based on what is known about the user, the seed, and the high-dimensional vector space. A negative indication may be removed or its effect in the system as having negative factors that weigh against its subsequent recommendation if, for example, the user specifically uses it as a seed or the user otherwise indicates an interest in the negatively indicated song. For example, the user may spend some time browsing a page on which the negatively indicated song is mentioned or sampling an album on which the negatively indicated song is a part.

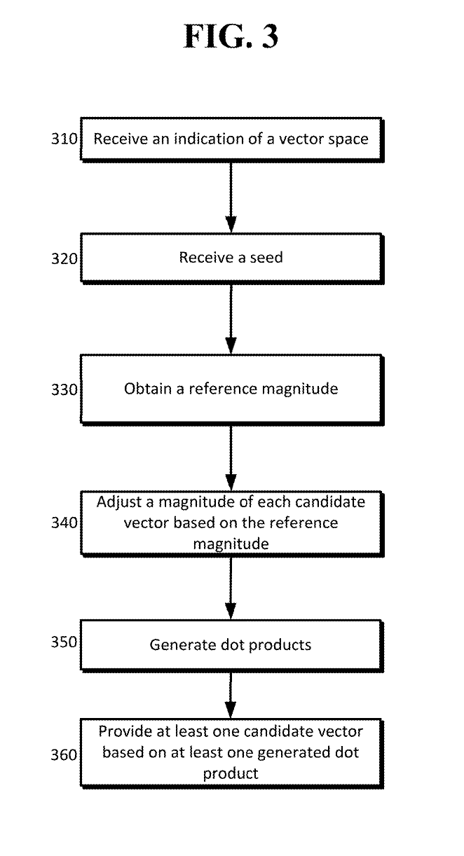

According to an implementation, an example of which is provided in FIG. 3, an indication of a vector space that includes one or more vectors may be received at 310. An indication may be receipt of one or more vectors in the space or, for example, a table stored in a database that indicates an identifier of an item and values for features contained in the vector. Each of the vectors may represent an item such as digital content (e.g., a book, a movie, a picture, a song), a user model, or a consumer good (e.g., a manufactured good that a consumer can purchase). An item may refer to a collection of digital content, user models, or consumer goods and may the collection may be represented as a vector in the vector space. For example, a collection of songs that make up an album from an artist may be represented as a vector. Likewise, all of the songs produced by a particular artist may be represented as a vector in the vector space. The vector space, as stated earlier, may be multidimensional. For example, dozens or hundreds of features of an item may be represented in a given vector and each feature may have its own dimension. A user model may be the product of a machine learning system or other techniques. It may define characteristics that are associated with the particular user based on explicit data (e.g., information about the user from the user's actions, behavior, or input) and/or implicit data (e.g., information associated with the user based on other similar users' actions, behaviors, or inputs). For example, a user model may describe information about the user as described earlier such as what genres of music a user prefers or the like. In some instances, the system may monitor a user's listening and build models that include data entries for features such as the time of day, how adventurous a user's listening habits are (i.e., how related is a user's music collection or the songs that the user listens too in terms of genre, artists, or features of the songs). For example, the user model may be used to discern that during the morning hours, a user is not particularly adventurous with respect to music tastes. But, during the afternoon time, the user prefers to explore beyond the user's usual music tastes. The information about the user as represented in a user model may be utilized to provide or adjust a reference popularity (or magnitude).

At 320, a seed may be received. The seed may be represented as a seed vector. The seed may correspond to, for example, a user's entry in a search for a recommendation, to an item as described earlier, etc. For example, a user may be streaming music content from the user's personal music collection. The user may elect to have the system provide songs that are similar to the one currently playing. The seed in such a case is the song currently playing. The seed vector may be determined by querying a database in which the currently played song is contained with the name, an identifier, audio signature, or other indication of what is currently playing. The database may return the vector for the seed. That is, the high-dimensional space may contain vectors for several songs, one of which is the currently playing song. The seed vector may define a direction in the vector space.

A reference magnitude may be obtained at 330. In some implementations, the magnitude of the seed vector may be utilized as the reference magnitude. A reference magnitude may be determined from a user model or other information about the user in some instances. For example, a user popularity value may be determined from the item type indicated by the seed. If the seed relates to a song, the reference popularity may be determined based on the average popularity of the songs in the user's personal collection or other similar statistical approximation or measure of the popularity of the user's personal music collection. Thus, the reference magnitude may be an inferred value for the depth of the user interest in a particular genre. In some configurations, the reference magnitude may be adjusted based on the information about the user and/or user model. For example, if the seed popularity is a value X and the user's reference popularity is Y, the reference magnitude may be adjusted by X+10% Y. This is one example of how the reference magnitude may be adjusted, other methods of adjusting the reference popularity may be utilized with any of the implementations disclosed herein.

The magnitude of each of one or more candidate vectors in the vector space may be adjusted based on the reference magnitude at 340. A candidate vector is one of the vectors in the vector space. In some implementations, however, it may be computationally efficient to narrow the number of vectors in the vector space to candidate vectors. For example, the seed vector may be utilized to cull the vectors in the vector space by selecting only those vectors that are within a threshold distance of the seed vector. That threshold value may be empirically determined to obtain a suitable number of candidate vectors. Each candidate vector, therefore, is a vector in the vector space and represents an item in the vector space. In some configurations, the candidate vectors for one or more seed vectors may be predetermined. For example, each vector in the vector space represents an item such as a song. Thus, if a song is submitted as a seed, it may be known to the system already exactly which vectors are among those possible to recommend to a user, ranging from unpopular but related to popular and related.

One or more dot products (e.g., inner products) may be may be generated by a processor at 350. Each dot product may be generated between one of the candidate vectors whose magnitude has been adjusted and the seed vector. Dot products may be stored in a database connected to the processor. As stated earlier, in some configurations, the dot products may be predetermined if the seed vector and candidate vectors alone are utilized. If, however, information about a user and/or a user model is used to adjust the reference magnitude or establish the reference magnitude, then the dot products may be determined ad hoc.

At least one of the dot products may be a basis for providing at least one of the candidate vectors to a user at 360. For example, providing a candidate vector may be in the form of returning a list of songs or a single song related to a user's query (e.g., the seed). The dot products may be ranked and a portion of the candidate vectors may be selected based on the ranking. For example, a threshold value may be established below which an item is not included in a list of items that are recommended to a user in response to receiving a seed or that are not shown to the user unless the user specifically prompts the system to make additional recommendations. In some configurations, the dot products may be provided to a recommendation system that may incorporate the dot products as a basis for a recommendation to a user.

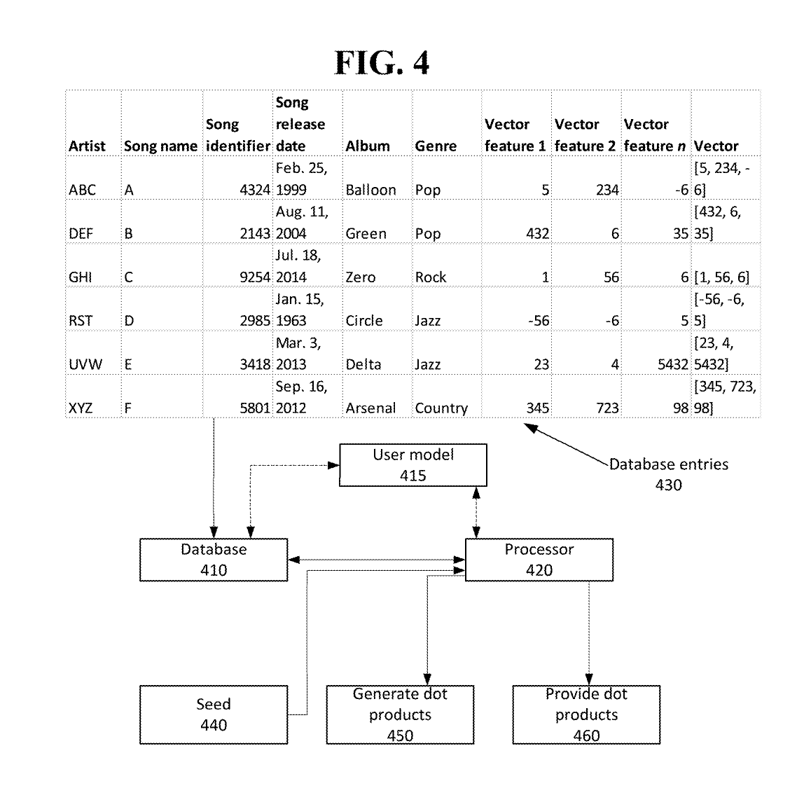

In an implementation, as shown by the example shown in FIG. 4, a system is provided that includes a database 410 and a processor 420. The database 410 may store one or more vectors. As described earlier, each vector may exist in a vector space and represent an item. The database 410 may store vectors as entries associated with other descriptions of an item. For example, a database entry for a song may contain the song's name, album name, release date, producer, genre, artist's name, band name, an identifier, etc. and/or some or all of these features may be represented in the vector for the song. In FIG. 4, an example table of database entries 430 is shown in which six different songs from six different artists are shown in the table 430. Vector feature 1, Vector feature 2, and Vector feature n may be numerical representations of individual entries for a given song or other features. For example, Vector feature 1 may be numerical representation for Artist. The vector features may refer to other facets of a song such as its run length, its audio signature or profile, its popularity, its sales, its popularity trend, purchase trend, purchase history, etc. The last column of the database entries 430, labeled as “Vector” contains vectors, some or all of which can be output to the processor 420. Separate database tables may exist in the database 410 for different types of items. For example, one table may contain entries only for songs while another contains entries only for movies. Even more specifically, tables may be broken apart by genre such that there may be one table for pop music and another table for jazz music. There may be overlap between various tables; that is, a pop musician may also be listed under a country music table. The database may store only vectors and a separate database may be responsible for storing other information about a given item (e.g., everything but the Vector column in FIG. 4's database entries 430).

Thus, the multidimensional vector space may be theoretical and not actually constructed or stored as such in the database 410. It may be what would be created if each of the vectors contained in the database 410 or a portion thereof were plotted. The database 430 may be populated with additional vectors as needed. For example, new music is constantly released and the database 410 may need to be updated or refreshed. Likewise, if the vectors are related to consumer goods, it may be necessary to remove certain goods from the database.

The processor 420 may be configured to receive an indication of the vector space. As stated earlier, the indication may be receipt of one or more vectors or database entries therefor. The processor 420 may receive a seed 440. For example, a user may be browsing a shopping web site and select an option to obtain recommendations for similar items as one of the items shown on the page or for items in a category represented by an item. The processor 420 may, in some configurations query the database 410 with the received seed 420 to obtain the seed vector. As stated above, the seed vector may be one of the entries in a database table. The processor 420 may obtain a reference magnitude as described above. A magnitude of each candidate vector may be adjusted based on the reference magnitude. The processor 420 may generate a dot product (e.g., inner product) as between each candidate vector and seed vector 450. The dot products 420 may be provided 460, for example, in the form of a list to the device from which the seed was received or output to a recommendation system that may incorporate the dot products 450 as a component of recommending an item as describe earlier.

In some configurations, a user model 415 may be utilized as the reference popularity magnitude or to adjust the reference magnitude. For example, the processor 420 may receive the seed 440 and query the database 410 to identify the vector corresponding to the seed 440. Based on the seed vector, the processor 420 may determine candidate vectors that are close to the direction of the seed vector. Proximity to the seed vector may be empirically determined and adjusted to obtain the desired level of diversity in a recommendation. The processor 420 may query the same database 410 or a different database to obtain the user's model 415 and/or an adjustment value contained therein. The adjustment value may be applied to, for example, the seed vector's magnitude to obtain the reference magnitude. The user's model may indicate that the user prefers to hear jazz music above other genres, dislikes country music entirely, and occasionally listens to classical music. Within the classical music genre, the user may prefer musicians from the Baroque era and not the Classical era. Candidate vectors from the database 410 may be retrieved based on the user's preferences as indicated by the user model. That is, no vectors corresponding to country music may be retrieved because this particular user would have no interest in hearing such content. In contrast, if the seed is a classical music piece, candidate vectors may be retrieved that correspond to compositions from the Baroque era composers. As another example, the user model may be utilized to adjust candidate vectors for each of the aforementioned genres and/or the seed vector's magnitude. For example, retrieved candidate vectors may have their respective popularities adjusted by +10% for jazz, +5% pop, +2.5% for classical music, and −50% for country. Similarly, the seed vector's reference popularity may be adjusted, for example, incrementally or as a percentage of the user model's indicated popularity for the genre corresponding to the seed. That is, if the seed corresponds to a jazz song or artist, the seed vector's reference magnitude may be increased by 10%.

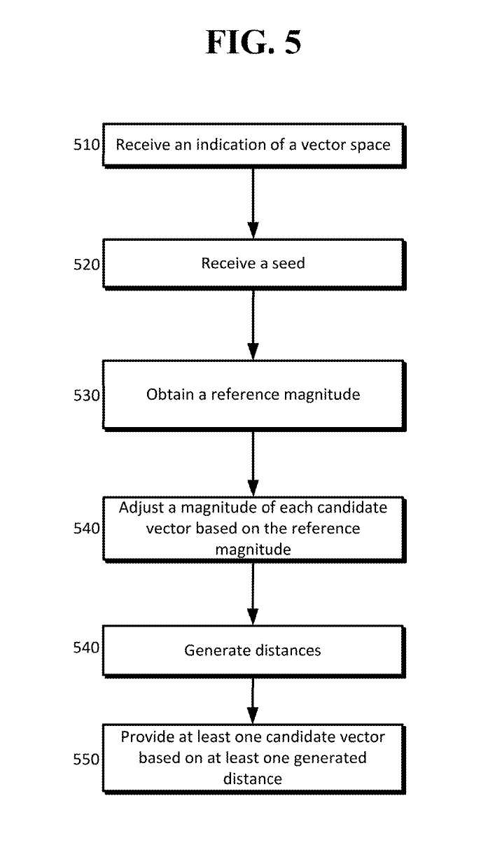

In an implementation, an example of which is provided in FIG. 5, an indication of a vector space that includes vectors, each of which represents an item, may be received as described earlier at 510. A seed may be received that corresponds to a request for a recommendation at 520. A reference magnitude may be obtained at 530. A magnitude of each of the candidate vectors in the vector space may be adjusted based on the reference magnitude at 540 as stated above. Each of the candidate vectors may represent an item in the vector space. A processor may generate distances between each of the candidate vectors with adjusted magnitude and the seed vector at 550. A distance may be obtained between a candidate vector's coordinates within the vector space as adjusted by the reference magnitude and the seed vector's coordinates within the vector space. The distance may be, for example, a Euclidean distance such as the L2 distance (i.e., L2 norm). At least one of the candidate vectors may be provided based on at least one of the generated distances obtained at 560. Each of the generated distances may be ranked and a portion of the candidate vectors may be selected based on the ranking of the distances.

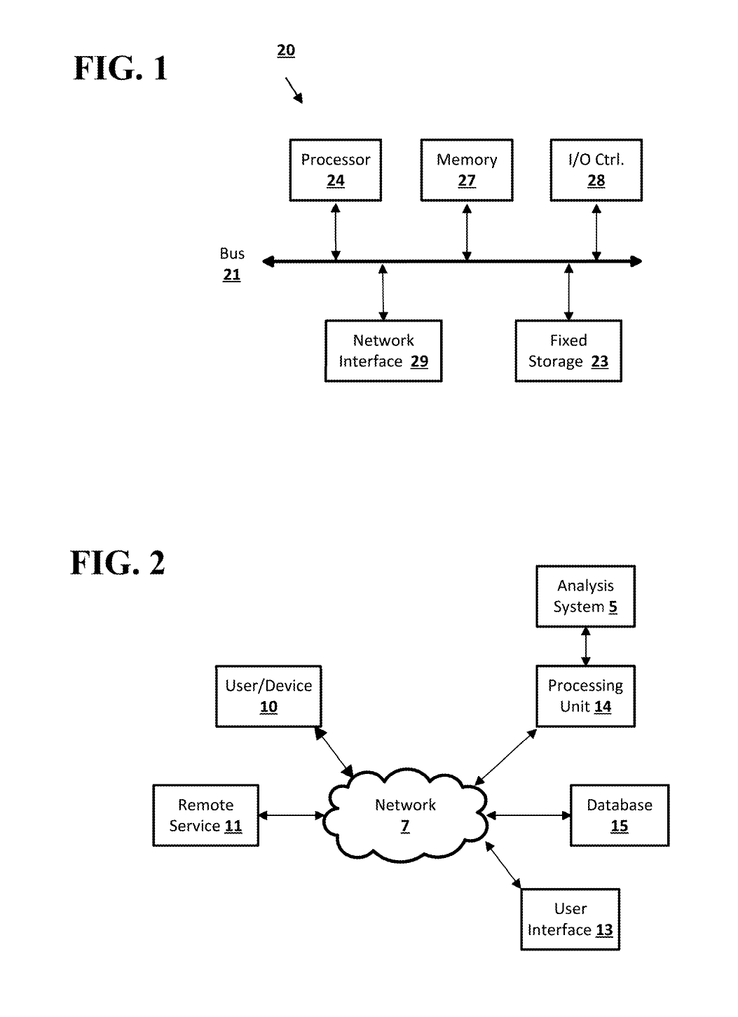

Implementations of the presently disclosed subject matter may be implemented in and used with a variety of component and network architectures. FIG. 1 is an example computer system 20 suitable for implementations of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 2.

Many other devices or components (not shown) may be connected in a similar manner, such as document scanners, digital cameras, auxiliary, supplemental, or backup systems, or the like. Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 2 shows an example arrangement according to an implementation of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

In situations in which the implementations of the disclosed subject matter collect personal information about users, or may make use of personal information, the users may be provided with an opportunity to control whether programs or features collect user information (e.g., a user's performance score, a user's work product, a user's provided input, a user's geographic location, and any other similar data associated with a user), or to control whether and/or how to receive instructional course content from the instructional course provider that may be more relevant to the user. In addition, certain data may be treated in one or more ways before it is stored or used, so that personally identifiable information is removed. For example, a user's identity may be treated so that no personally identifiable information can be determined for the user, or a user's geographic location associated with an instructional course may be generalized where location information is obtained (such as to a city, ZIP code, or state level), so that a particular location of a user cannot be determined. Thus, the user may have control over how information is collected about the user and used by an instructional course provider.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method, comprising:
receiving an indication of a vector space comprising a plurality of vectors, wherein each vector in the vector space represents an item;
receiving a seed, wherein the seed corresponds to a request for a recommendation;
obtaining a reference magnitude;
adjusting a magnitude of each of a plurality of candidate vectors in the vector space based on the reference magnitude, wherein each of the plurality of candidate vectors represents the item in the vector space;
generating, by a processor, a plurality of dot products, wherein each of the plurality of dot products is between one of the plurality of candidate vectors with adjusted magnitude and a seed vector;
providing at least one of the plurality of candidate vectors based on at least one of the plurality of dot products.

2. The method of claim 1, wherein the item is selected from the group consisting of: a user model, a song, a movie, a picture, and a book.

3. The method of claim 1, wherein the seed is selected from the group consisting of: a user model, a song, a movie, a picture, and a book.

4. The method of claim 1, wherein the reference magnitude comprises a magnitude of the seed vector.

5. The method of claim 1, wherein the reference magnitude comprises a magnitude of a user popularity value.

6. The method of claim 1, further comprising selecting the plurality of candidate vectors based on a direction of the seed vector.

7. The method of claim 1, further comprising ranking the plurality of dot products.

8. The method of claim 1, further comprising selecting a portion of the plurality of candidates based on the ranking of the plurality of dot products.

9. The method of claim 1, wherein the seed comprises the seed vector that defines a direction in the vector space.

10. A system, comprising:
a database for storing a plurality of vectors, wherein each vector exists in a vector space and represents an item;
a processor connected to the database and configured to:
receive an indication of a vector space, wherein the indication comprises at least a portion of the plurality of vectors;
receive a seed, wherein the seed corresponds to a request for a recommendation for an item;
obtain a reference magnitude;
adjust a magnitude of each of a plurality of candidate vectors in the vector space based on the reference magnitude, wherein each of the plurality of candidate vectors represents the item in the vector space;
generate a plurality of dot products, wherein each of the plurality of dot products is between one of the plurality of candidate vectors with adjusted magnitude and a seed vector;
provide at least one of the plurality of candidate vectors based on at least one of the plurality of dot products.

11. The system of claim 10, wherein the item is selected from the group consisting of: a user model, a song, a movie, a picture, and a book.

12. The system of claim 10, wherein the seed is selected from the group consisting of: a user model, a song, a movie, a picture, and a book.

13. The system of claim 10, wherein the reference magnitude comprises a magnitude of the seed vector.

14. The system of claim 10, wherein the reference magnitude comprises a magnitude of a user popularity value.

15. The system of claim 10, the processor further configured to select the plurality of candidate vectors based on a direction of the seed vector.

16. The system of claim 10, the processor further configured to rank the plurality of dot products.

17. The system of claim 10, the processor further configured to select a portion of the plurality of candidates based on the ranking of the plurality of dot products.

18. The system of claim 10, wherein the seed comprises the seed vector that defines a direction in the vector space.

19. A computer-implemented method, comprising:
receiving an indication of a vector space comprising a plurality of vectors, wherein each vector in the vector space represents an item;
receiving a seed, wherein the seed corresponds to a request for a recommendation;
obtaining a reference magnitude;
adjusting a magnitude of each of a plurality of candidate vectors in the vector space based on the reference magnitude, wherein each of the plurality of candidate vectors represents the item in the vector space;
generating, by a processor, a plurality of distances, wherein each distance is between one of the plurality of candidate vectors with adjusted magnitude and a seed vector; and
providing at least one of the plurality of candidate vectors based on the at least one of the plurality of distances obtained.

20. The method of claim 19, wherein the item is selected from the group consisting of: a user model, a song, a movie, a picture, and a book.

21. The method of claim 19, wherein the seed is selected from the group consisting of: a user model, a song, a movie, a picture, and a book.

22. The method of claim 19, wherein the reference magnitude comprises a magnitude of the seed vector.

23. The method of claim 19, wherein the reference magnitude comprises a magnitude of a user popularity value.

24. The method of claim 19, further comprising selecting the plurality of candidate vectors based on a direction of the seed vector.

25. The method of claim 19, further comprising ranking the plurality of distances.

26. The method of claim 19, further comprising selecting a portion of the plurality of candidates based on the ranking of the plurality of distances.

27. The method of claim 19, wherein the seed comprises the seed vector that defines a direction in the vector space.

28. The method of claim 19, wherein each of the plurality of distances comprises a L2 distance.
